(19) United States
(12) Patent Application Publication
(10) Pub. No.: US 2002/0033880 A1
(43) Pub. Date: Mar. 21, 2002

(54) Method for performing multipoint video conference in video conferencing system

(76) Inventors: Dong-Myung Sul, Taejon (KR); Doo-Hyeon Kim, Taejon (KR); Kyung-Hee Lee, Taejon (KR); Seung-Min Park, Taejon (KR); Min-Gyu Kang, Taejon (KR); Seung-Ku Hwang, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,325

(22) Filed: Dec. 27, 2000

(30) Foreign Application Priority Data
Sep. 19, 2000 (KR) 2000-54808

(51) Int. Cl. H04N 7/14

(52) U.S. Cl. 348/14.09

(57) ABSTRACT

In a method for performing a multipoint video conference in a video conferencing system and a computer-readable record media storing a plurality of instructions for performing the method, the floor is given to participants of a conference so that the multipoint video conference can be progressed without a necessity of an MCU, and audio/video streams of the participants who actually utter in the conference can be selectively transmitted according to a capability of a transmission system. In the inventive method and recording medium, the method includes a first step of performing an initializing work so that a chairman of the conference can manage the conference based on a multipoint type; a second step of giving a given floor to a large number of participants who request the floor after the initializing work, through an active multipoint controller (MC); and a third step of selectively transmitting an audio and video stream of the participants who substantially utter in the conference according to the capability of an active transmission system in order to execute the given floor, thereby being utilized in a video conferencing system.

### FIELD OF THE INVENTION

The present invention relates to a method for performing a multipoint video conference in a video conferencing system and a recording medium capable of being read through a computer having a program to realize the inventive method; and, more particularly, to a method for performing a multipoint video conference in a video conferencing system and a recording medium capable of being read through a computer having a program to realize the inventive method, by giving the floor so that a plural number of video conference participants can progress a multipoint video conference through a use of a computer connected to a communication network, and by transmitting his/her own audio and video stream or seeing videos and listening to voice of other participants so that he/she can participate in the conference.

### PRIOR ART OF THE INVENTION

A multipoint video conference is hierarchically designed and is classified into a data transmission, an audio and video compression system and an H.323 protocol hierarchy which takes charge of a generation and a management of a multipoint conference.

In general, video conference participants perform a video conference program in their own computers connected to a network, thus they can take part in a video conference. By the way, in order to progress a multipoint video conferenceusing the H.323 standard, a multipoint control unit(MCU) is needed, wherein the MCU is composed of a multipoint controller (MC) taking charge of a central control for a multipoint video conference, and a multimedia processor (MP) for synthesizing amultipoint audio and video stream as one stream and performing a multicasting.

Conventionally, in order to progress the multipoint video conference, all of audio and video stream of the participants is transmitted to all the participants, or is transmitted to the participants by re-constructing a screen through a use of an MP equipment. Herewith, in a case of the former, figure and voice of all the participants can be shown and listened, but in this case, according that the number of the participants increases, a transmission quantity of data also increases in a geometric progression so a system of a user also has an overload. Thus, the system can not operate smoothly. In a case of the latter, not only the MP equipment is a hardware equipment based on a high price, but also it has a burden to generally use even though the number of the participants becomes better than the former.

### SUMMARY OF THE INVENTION

Therefore, it is an object of the present invention to provide a method for performing a multipoint video conference in a video conferencing system and a recording medium capable of being read through a computer having a program to realize the inventive method, by giving the floor to participants of a conference so that the multipoint video conference can be progressed without a necessity of an MCU, thus by selectively transmitting an audio and video stream of the participants who actually utter in the conference according to a capability of a transmission system.

In accordance with the present invention to achieve the objects, a method for performing a multipoint video conference in a video conferencing system includes a first step of performing an initializing work so that a chairman of a conference can manage the conference based on a multipoint type; a second step of giving a given floor to a large number of participants who request the floor after the initializing work, through an active multipoint controller (MC); and a third step of selectively transmitting an audio and video stream of the participants who substantially utter in the conference according to a capability of an active transmission system in order to execute the given floor.

In the invention, it is further provided a recording medium, which is capable of being read in a video conferencing system having a processor, through a computer having a record of a program to realize functions of performing an initializing work so that a chairman of a conference can manage the conference based on a multipoint type; giving a given floor to a large number of participants who request the floor after the initializing work, through an active multipoint controller(MC); and selectively transmitting an audio and video stream of the participants who substantially utter in the conference according to a capability of an active transmission system in order to execute the given floor.

In the invention, in order for a multipoint video conference without a multimedia processor (MP) of a hardware equipment, it is proposed a method of transmitting only an audio and video stream of a participant who has the floor, among the participants of the conference, and herewith the number of the floors is limited to two. That is, in this method, the participant himself/herself can see images of two persons except the participant himself/herself, in other words, he/she can see and listen to contents two uttering persons excepting himself/herself converse with each other. Herewith, except a conference of a difficulty debate type, even though several persons take part in the conference, it is possible to progress the conference in such a type that two persons converses with each other and the rest persons listen to. Therefore, the floor is permitted by two without deviating from a range of the H.323 standard, to thus progress the multipoint conference even though it is the video conference in which several tens of people take part in.

In addition, in accordance with the present invention, the floor of the participant is managed by compensating a function of the multipoint controller (MC). In a case of a one to one video conference or a tripartite video conference, all the participants have the floor. But, in case that the conference is developed as the conference of a multipoint type more than a four-party talk, the floor should be limited to two to reconstruct the conference. Further, in case there is an occurrence of a change for the floor in the midst of a conference progression, information of systems corresponding to the respective participants is adjusted by stopping a transmission of one out of streams according to its change so as to transmit a new stream.

That is to say, the multipoint controller (MC) is required for the sake of the multipoint conference more than the tripartite talks. Herewith, a capability set can be exchanged between terminals that the respective participants use, various functions for a control of the floor or a determination of a conference mode are performed, a newly compounded capability set is advised to the terminal side so that a new conference mode can be determined whenever the participant enters or secedes from the conference according that the multipoint conference is progressed, and further, a selected communication mode(SCM) is dynamically decided through these serial procedure. In order to use such multipoint controller (MC), all the terminals are connected to the MC through an H.245 control channel in determining the conference. In a method for a connection with the MC, there are several methods, like paging an MCU as an aggregate of the MC and the MP or paging the MC provided within a gatekeeper, etc., but in the invention, its connection can be obtained by selecting an MC among the MCs existing within the respective terminals through a master/slave resolution procedure. Namely, the selected MC is named an active MC and it can be gained through a connection with this active MC.

Meanwhile, in the present invention, in a transmission of a stream it can be selectively transmitted through an audio or a video according to a capability of a transmission system. In the invention, also, a transmission side monitors a QoS (Quality of service) change status by using an RTCP (RTP Control Protocol) information and then predicts its change, and on the basis of this prediction value, a data generation quantity of the video or the audio, or an FEC(Forward Error Correction) additional information quantity necessary for a recovery of a loss in a receiving side are controlled.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary diagram representing a correlation between a video conferencing system and an H.323 protocol in accordance with the present invention;

FIG. 2 illustrates an exemplary diagram of an actually progressing screen in a multipoint video conference applied to the present invention;

FIG. 3 depicts an exemplary diagram for a terminal equipment of the multipoint video conference in the video conferencing system in the invention;

FIG. 4 provides an exemplary diagram for a multipoint conference controller provided in the multipoint video conference of the video conferencing system in the invention;

FIG. 5 is an exemplary diagram showing a message passing module for a block A of FIG. 4;

FIG. 6 is an exemplary procedure diagram representing a procedure an end point 3 shown in FIG. 5 requests the floor;

FIG. 7 is an exemplary flowchart for a method of the multipoint video conference in the inventive video conferencing system;

FIG. 8 illustrates an exemplary flow chart presenting a procedure that a chairman of a conference manages the floor in the method of the multipoint video conference in the inventive video conferencing system; and

FIG. 9 is an exemplary flow chart showing a procedure that an participant of a conference tries to utter in the method of the multipoint video conference in the inventive video conferencing system.

### PREFERRED EMBODIMENT OF THE INVENTION

Hereinafter, preferred embodiments of the present invention will be described in detail with reference to the accompanying drawings.

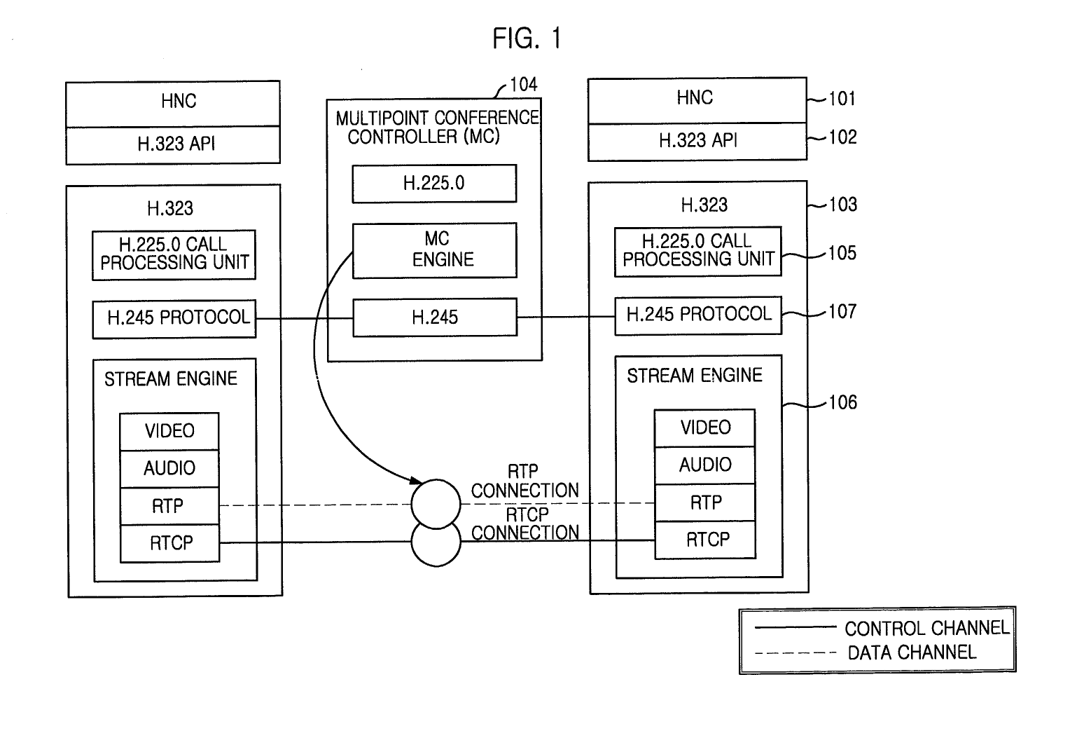

FIG. 1 is an exemplary diagram showing a correlation between a video conferencing system and an H.323 protocol in accordance with the present invention.

As shown in FIG. 1, the video conferencing system operates over an H.323, 103, and API (Application Programming Interface) 102 is the block for supplying a library type API so that multipoint video conferencing system and an HNC 101 add a user interface etc. to the H.323 103 so as to make it an application program.

The multipoint controller (MC) 104 is a block to take charge of a conference control such as a conference mode determination and a capability exchange between participants of a multipoint conference, a control of the floor, a multicast address management 208, etc. by using an H.245 107.

An H.225.0 105 is a block for taking charge of a signaling concerning of a call process such as a generation and a participation of the multipoint video conference, an invitation and a conference completion, etc.

A stream engine 106 is a block for taking charge of a multithreading between a CODEC and a communication protocol stack for the sake of a real time streaming of an audio and a video, and is constructed by details modules, as an audio/video software CODEC module, an RTP protocol 109 process module for an audio/video communication, and an RTCP protocol 110 process module for a QoS control of the audio/video communication.

The H.245 107 is connected to the MC 104 so that respective terminal sides can perform the H.245 protocol.

Meanwhile, an MCU is needed to perform the multipoint video conference using the H.323 103. The MCU is composed of an MC for taking charge of a central control for the multipoint video conference, and a multimedia processor (MP) for synthesizing multipoint audio and video streams into one stream and performing a multicasting. Herewith, the MC can be embodied by a software through the H.245 107 but the MP should be embodied by a private processor or hardware since it has a video process part. However, this is on the basis of an assumption for a status that a recovery capability of a terminal participated in the conference is limited to only one video stream. If the H.323 103 is embodied by considering only such status, it is naturally impossible to execute a multipoint conference under a circumference there is no the MP.

Therefore, in the invention, a software CODEC capable of recovering two H.261 video streams at the same time is used so as to execute the tripartite simultaneous video conference even without the MP first. This tripartite simultaneous video conference means that any participant can see screens of two persons excepting himself/herself, that is, it means that any participant can see contents that two speakers converse with each other, except himself/herself. Except a difficult discussion type conference, it can be progressed in such a state that two persons converse with each other and the rest people listen to at an optional time point even though several people generally take part in the conference. In the invention, without deviating from a range of the standard of the H.323 103, the floor can be permitted till two so that the conference can be progressed even though it is the conference in which tens of people take part in. Particularly, such multipoint conference has an economic advantage as the conference can be progressed even without the MP.

Herewith, a data transmission protocol used in the H.323 103 is an internet protocol (IP) multicast protocol and is the unreliable protocol in which a loss of data can occur according to an existence or nonexistence of a load caused on a network. Thus, in the H.323 103, a network QoS value of an audio or video packet transmitted, namely, a delay, a jitter, a loss rate, a transmission rate, etc., can be measured by defining a realtime transport protocol (RTP) over an IP multicast. However, since it can not become any solution for preventing the loss of data only with the RTP, in the H.323 103 a QoS control protocol as an RTP control protocol (RTCP) is defined together with the RTP. A principle characteristic of this RTCP is that the QoS value measured from the RTP packet an optional terminal receives, is again multicasted and is fed back. In other words, a transmitting side monitors a QoS change status by using such RTCP information to thus predict its change, and on the basis of such prediction value, a video or audio data generating quantity or a quantity of FEC (Forward Error Correction) additional information which is necessary for a recovery of the loss in a receiving side, are controlled. Such method has an improvement in a realtime nature than a method of performing a retransmission to recover a lost packet.

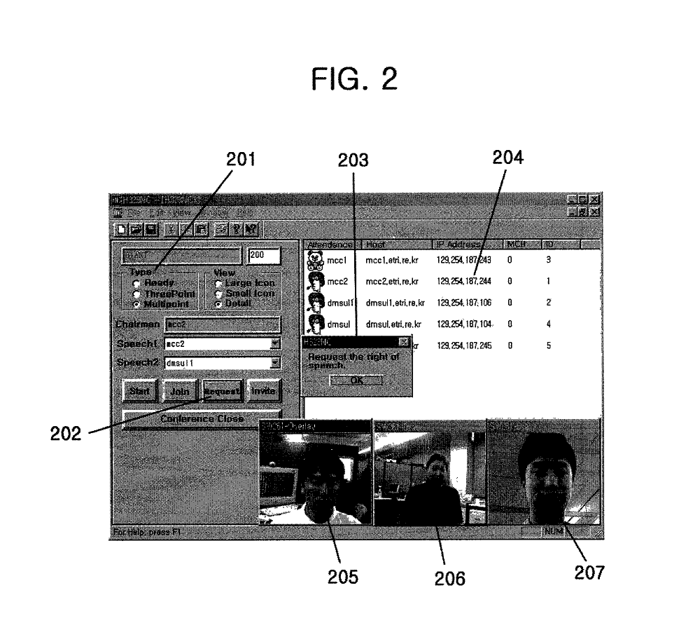

FIG. 2 is one exemplary diagram for an actual progress screen of the multipoint video conference in accordance with the present invention. In FIG. 2, it is shown features of general participants who do not have the floor in a multipoint type conference in which 5 persons take part in.

As shown in FIG. 2, a left frame 201 indicates, information concerning of the conference, whether or not a form of a current conference is being prepared, whether it is a tripartite or multipoint conference, who a chairman of the current conference is, and who a participant having the floor is. Also, the left frame 201 takes charge of a conference controlling function such as an establishment of a conference, an invitation, a request for a participation and the floor, etc. When pressing a floor request button 202 to request the floor, a request confirmation message window 203 appears to transfer a corresponding message to the chairman of the conference.

Meantime, a right frame 204 in the drawing indicates information of the participants who currently take part in the conference, and shows a screen 205 of himself and images of a speaker 1 (206) and a speaker 2 (207) who have the floor currently. His/her own screen is always maintained and the images of the speakers are changed according to a change of the floor. Thus, in case the person himself has the floor, one out of two images disappears. Also, in case there is no function of a video transmission at a side of a participant who has the floor, the conference is progressed, showing a vacant image screen of a state that there is no a corresponding video screen.

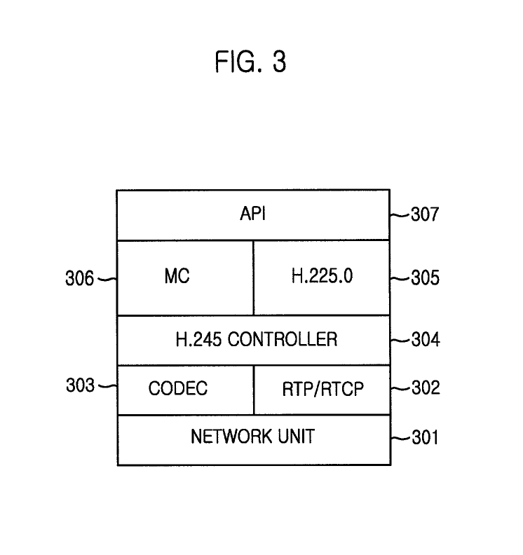

FIG. 3 is one exemplary diagram for a terminal equipment of a multipoint video conference in the inventive video conferencing system.

As shown in FIG. 3, it is constructed by a network part 301 for a communication, an RTP/RTCP 302 as a protocol for actually transmitting data through the network part 301, a CODEC 303 as a software for recovering compressed and received when an audio and video stream is transmitted through the network part 301, an H.245 controller 304 for a conference control, an H.225.0 305 for a connection determination, and an MC 306 and an API 307 provided to exchange a capability set between the terminals so that the multipoint conference can be progressed and for performing various functions such as a control of the floor or a determination of a conference mode etc.

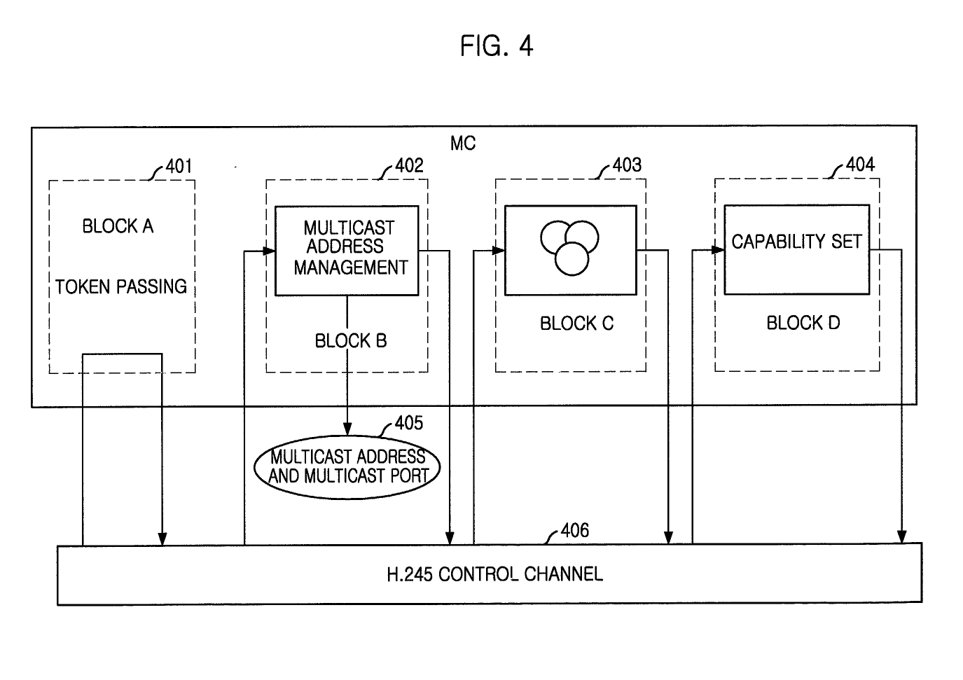

Herewith, the MC 306 uses the H.245 protocol as shown in FIG. 4, and is constructed by four blocks like A, B, C and D.

Each block is constructed by a procedure of executing a control function required through an H.245 control message, and this result for this procedure is also transmitted to respective H.323 endpoints taking part in the conference, through the H.245 control message. An execution function of each block provided in the MC 306 is as shown in FIG. 4 to be mentioned later.

FIG. 4 is one exemplary diagram of a multipoint conference controller among multipoint video conference equipments in the video conferencing system in accordance with the present invention.

As shown in FIG. 4, the block A 401 performs a function of routing the H.245 control message received through an H.245 control channel 406 to another endpoints taking part in the conference.

The block B 402 executes a function of generating and managing a multicast address and multicast port 405 for the sake of a data transmission in generating a multipoint conference.

The block C 403 analyzes the capability sets of the individual endpoints taking part in the multipoint conference, and defines and manages an SCM (Selected Communication Mode) of the endpoints having the least capability which is necessary for an execution of the conference.

The block D 404 manages the capability set of the respective endpoints taking part in the multipoint conference.

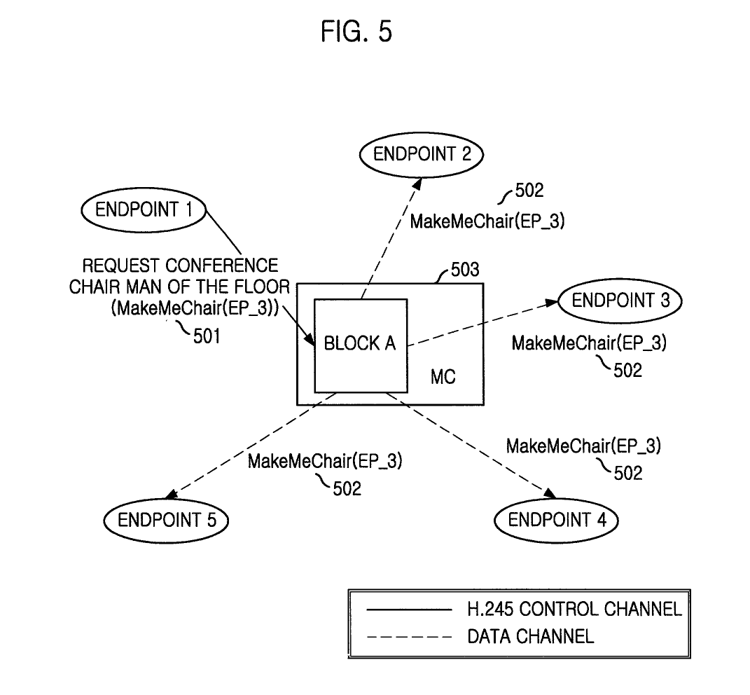

FIG. 5 is one exemplary diagram showing a message passing module for the block A of FIG. 4, and this module performs a function of routing the H.245 control message received through the H.245 control channel to other endpoints taking part in the conference.

As shown in FIG. 5, it represents a function of routing a control message of an endpoint participating in the multipoint conference to other endpoints participating in the multipoint conference. As one example for a function of the block A 503, it is shown that the floor is given to the endpoint 1 which requests the chairman of the conference for the floor in 501 and this fact is routed to other endpoints participating in the conference in 502.

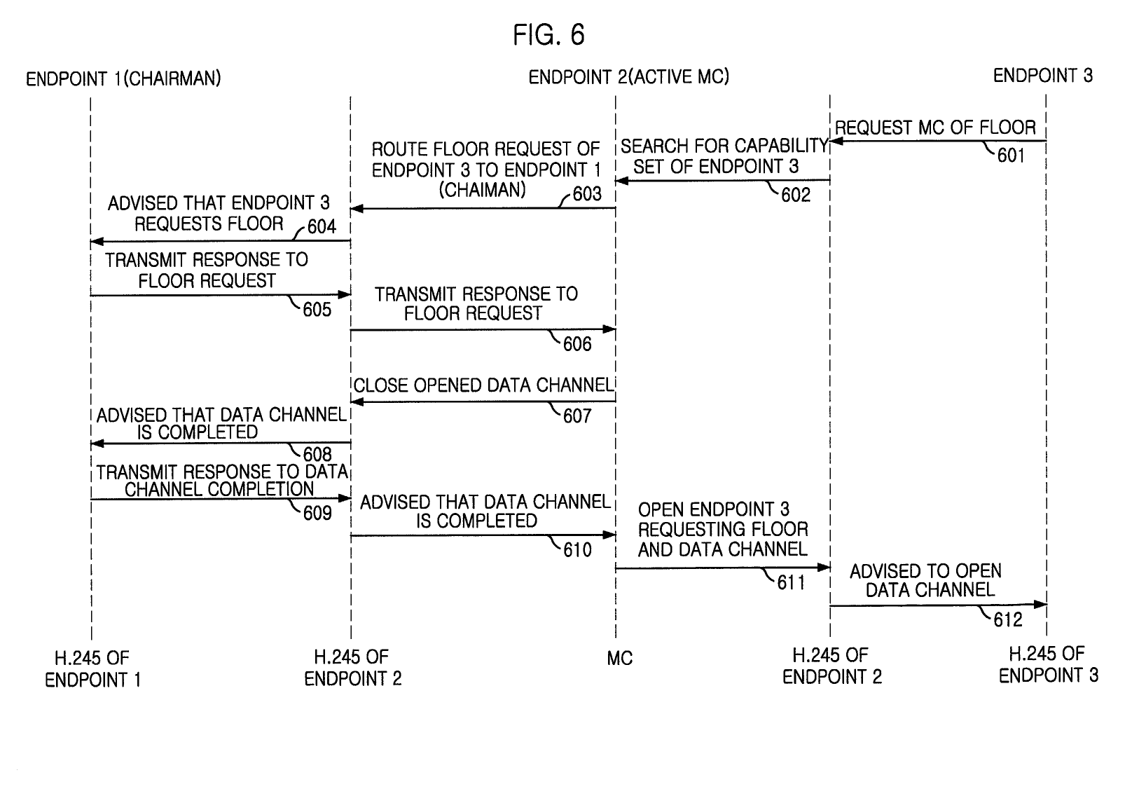

FIG. 6 is one exemplary procedure diagram showing a procedure the endpoint 3 of FIG. 5 requests the floor.

First, the endpoint 3 requests the MC 306 for the floor, in 601.

Then, the endpoint 2 as an active MC receives the request of the endpoint 3 for the floor, after that, searches the capability set of the endpoint 3 in 602, and routes the floor request fact of the endpoint 3 to the endpoint 1 as the chairman, in 603.

Subsequently, the endpoint 1 as the chairman receives an advice for the floor request of the endpoint 3 from the endpoint 2 as the active MC, in 604, and transmits a response to the received floor request, to the endpoint 2 as the active MC, in 605 and 606, and then, the endpoint 2 as the active MC closes a currently opened data channel in 607. After that, the endpoint 1 as the chairman having the data channel receives an advice for a finish of the data channel in 608, and responses to the advice of the data channel finish in 609. Then, the endpoint 2 as the active MC having a receipt of the advice for the data channel finish in 610, opens the data channel with the endpoint 3 which requests the floor, in 611.

After that, the endpoint 3 receives an advice that the data channel will be opened, from the endpoint 2 as the active MC, in 612.

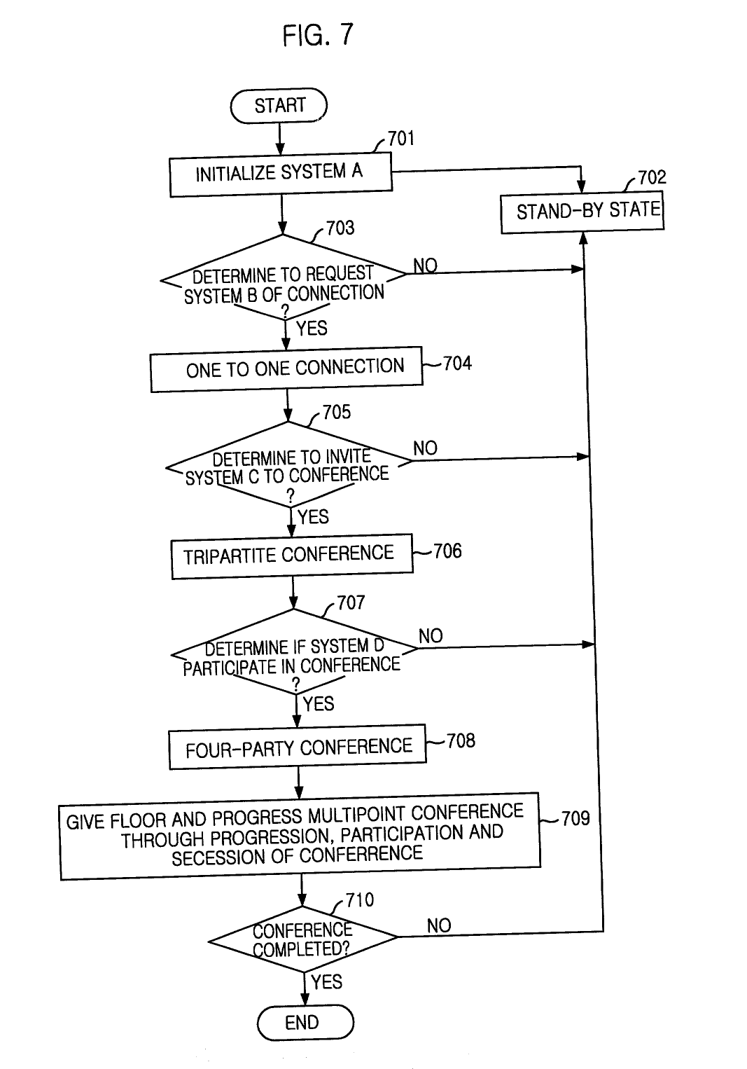

FIG. 7 is one exemplary flow chart for a multipoint video conferencing method in the inventive video conferencing system.

As shown in FIG. 7, in 701 the H.323 terminal as a system A is operated to thus operate the H.323 protocol and perform an initializing work in which his/her own capability set is constructed. When the initializing work is completed, it is decided whether it becomes a stand-by state waiting for a connection request of another terminal in 702 or it will be requested the H. 323 terminal as a system B for a connection to another terminal in 703.

As its decision result, if himself as the system A does not request another H.323 terminal as the system B for the connection, it becomes the stand-by state (702) waiting for a connection request of another terminal, and if it is requested a connection to another H.323 terminal as the system B, a one-to-one connection (704) is gained with the H.323 terminal as the system B.

At this time, the active MC is decided, and it is not surely necessary that the chairman of the conference becomes the active MC since such procedure accords to the H.323 standard.

Then, it is decided in 705 whether other H.323 terminal as a system C is invited or not, and if not invited, it becomes a stand-by state waiting for a connection request of other terminal, in 702. If other H.323 terminal as the system C is invited, the tripartite conference is formed in 706. In this case, all the participants have the floor and can give and take mutual videos.

Meanwhile, it is decided in 707 whether a still another H.323 terminal as a system D will be participated in the conference in the midst of the tripartite conference, and if not participated in, it becomes the stand-by state waiting for a connection request of other terminal in 702. If participated in, it is automatically changed a four-party conference, namely, a multipoint type conference and the floor is limited to two in 708.

In this case, the floor is given according to a decision of the conference chairman, and the multipoint conference is progressed through a progression, a participation and a secession in the conference. After that, even though the participants increase, only a system having the floor can multicast the stream. Therefore, the conference is progressed in a state that other systems can only receive the stream, in 709. If it is wanted to finish the conference in 710, the chairman of the conference can perform a command of the conference completion. If it is not wanted to finish the conference, it becomes the stand-by state waiting for a connection request of other terminal, in 702.

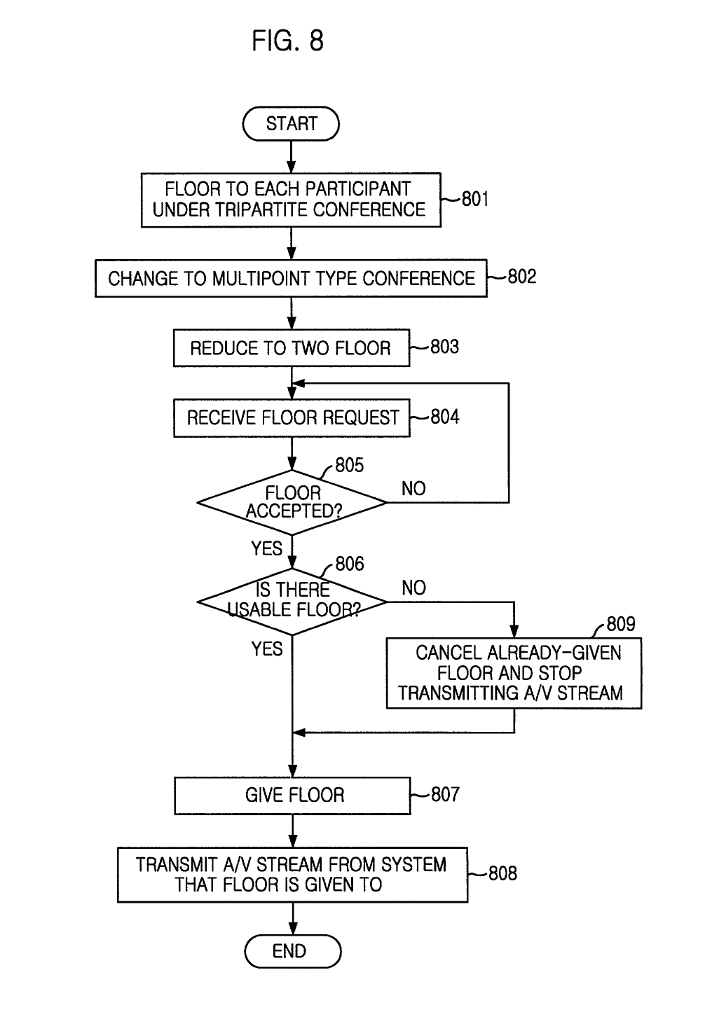

FIG. 8 is one exemplary flow chart showing a procedure that the chairman of the conference manages the floor in the multipoint video conferencing method in the inventive video conferencing system.

As shown in FIG. 8, if the conference is changed to the multipoint type conference in 802 according that individual participants have the floor in the midst of the tripartite conference progression in 801, the floor is automatically reduced to two floors by the active MC in 803.

After that, when the request for the floor is received in 804, the chairman decides whether the floor is acceptable or not, in a step 805, and if the floor request is not accepted, it is passed to a step 804 of receiving the floor request. If the floor request is accepted, it is confirmed whether there is first a usable floor, in a step 806.

In its confirmation result, if there is the usable floor, the floor is given in a step 807, and a multicast address and a multicast port number to transmit the stream to a corresponding system are known, and an advice for the floor given is provided to other systems to thus transmit an audio/video (A/V) stream in a step 808.

In its confirmation result, if there is no the usable floor, a cancel for the floor is advised to the system having the floor given already, then a stop for a transmission of the audio/video (A/V) stream is requested in a step 809, and then it becomes a step 807 of giving the floor. In other words, the system in which the floor is cancelled, stops transmitting the stream right now and informs the chairman of its result so as to ensure the floor. Also, the system which ensures the floor, transmits its own stream to the multicast address and the multicast port number.

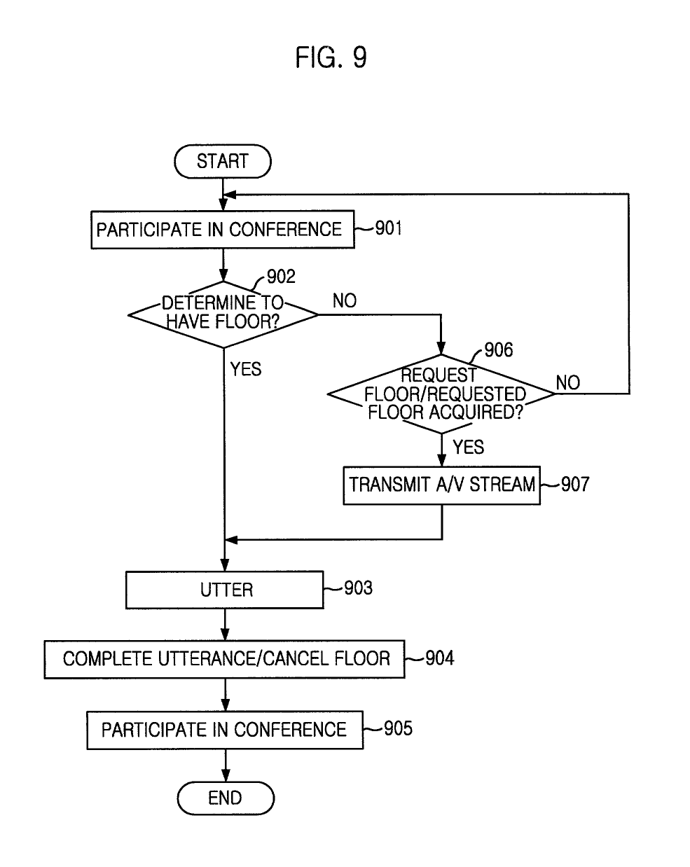

FIG. 9 is one exemplary flow chart showing a procedure that the participants of the conference utter, in the multipoint video conferencing method in the inventive video conferencing system.

As shown in FIG. 9, in case that himself/herself tries to utter in the midst of the participation of the conference in a step 901, it is confirmed whether or not himself/herself has the floor in a step 902. If there is the floor, he/she starts to utter in a step 903. After a completion of the utterance, he/she continuously takes part in the conference in a step 905 under a state that he/she has the floor or his/her floor is cancelled in a step of 904. If there is no the floor, it is clarified whether the floor is ensured in a step 906 after he/she requests the chairman for the floor.

If the request is not accepted in its clarification result, it becomes a step 901 of participating in the conference, and if the request for the floor is accepted, his/her own audio/video (A/V) stream is transmitted in a step 907, and then, it becomes a step 903 of beginning the utterance.

As afore-mentioned, in accordance with the present invention, a multipoint video conference can be progressed on an internet with only a software without using a hardware equipment or a specific transmission system. In addition, there is an effect of reducing a quantity of a data transmission since a chairman of a conference has all the rights in progressing the conference, gives the floor to participants, and thereby, only the participant having the floor can utter.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A method of multipoint video conference in a video conferencing system comprising:
a first step of performing an initializing work so that a chairman of a conference can manage the conference based on a multipoint type;
a second step of giving a given floor to a large number of participants who request the floor after the initializing work, through an active multipoint controller(MC); and
a third step of selectively transmitting an audio and video stream of the participants who substantially utter in the conference according to a capability of an active transmission system in order to execute the given floor.

2. The method according to claim 1, wherein said first step constructs a capability set of the anticipant so that process available stream among the audio and video stream is given and taken.

3. The method according to claim 2, wherein said active MC informs all the anticipants of change information in a case of changing the floor, exchanges the capability set so that the audio and video stream of the anticipant, given newly, is selectively transmitted, and performs a control for the floor or a conference mode determination function.

4. The method according to claim 3, wherein said second step comprises:
a fourth step of clarifying whether there is a soluble foot in the given foot;
a fifth step of giving the floor right away if there is the soluble floor in a clarification result of the fourth step, informing of a multicast address and a multicast port number for transmitting the stream to a corresponding system, advising a fact for a floor giving to the rest systems, and transmitting the audio and video stream; and
a sixth step of advising a cancel for the floor to a system having the floor given already if there is no the soluble floor in the clarification result of the fourth step, requesting a stopping for a transmission of the audio and video stream, and then returning to said fifth step.

5. The method according to claim 3, wherein said participants to try to utter in said third step perform the procedures including:
a fourth step of checking whether or not there is in the participant himself the floor in order that the participant himself utters in the midst of a participation of a multipoint conference;
a fifth step of starting an utterance if there is the floor in said fourth step and inspecting the conference under such a state that the floor is cancelled after a completion of the utterance or the floor exists;
a sixth step of requesting the chairman of the conference to give the floor if the participant himself has no the floor, and checking whether or not the floor is ensured; and
a seventh step of repeatedly performing from said fourth step in which the participant takes part in the multipoint conference if the request is not accepted in a checking result of said sixth step, transmitting the audio and video stream of the participant himself if the request for the floor is accepted, and then, returning to said fifth step.

6. A record media in a video conferencing system having a processor, characterized in that said record media is capable of being read through a computer having a record of a program to realize functions of:
performing an initializing work so that a chairman of a conference can manage the conference based on a multipoint type;
giving a given floor to a large number of participants who request the floor after the initializing work, through an active multipoint controller(MC); and
selectively transmitting an audio and video stream of the participants who substantially utter in the conference according to a capability of an active transmission system in order to execute the given floor.
